(19) United States
(12) Patent Application Publication
(10) Pub. No.: US 2026/0288507 A1
(43) Pub. Date: Sep. 24, 2026

(54) ABNORMALITY DETECTION DEVICE, ABNORMALITY DETECTION METHOD, AND ABNORMALITY DETECTION PROGRAM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Kyosuke MASUKAWA, Osaka-shi, Osaka (JP); Kunito FUKUDA, Osaka-shi, Osaka (JP); Shinichi AIBA, Yokkaichi-shi, Mie (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 19/479,742

(22) PCT Filed: Mar. 21, 2024
(86) PCT No.: PCT/JP2024/011083

§ 371 Date: Oct. 29, 2025

(30) Foreign Application Priority Data
Jun. 7, 2023 (JP) 2023-094215

(51) Int. Cl. G06F 9/455

(52) U.S. Cl. CPC G06F 9/45558; G06F 2009/45583; G06F 2009/45587

(57) ABSTRACT

Provided is an abnormality detection device that detects an abnormality in one or more virtual systems included in a virtualization system configured on hardware. The abnormality detection device includes: a measurement unit configured to measure at least one of a first period and a second period in a repetition of the first period and the second period, the first period being an execution period of the virtual system, the second period being an execution period of a virtual machine executed in the virtual system; and an abnormality detection unit configured to detect an abnormality in the virtual system, based on at least one of the first period and the second period measured by the measurement unit.

### TECHNICAL FIELD

The present disclosure relates to an abnormality detection device, an abnormality detection method, and an abnormality detection program. This application claims priority on Japanese Patent Application No. 2023-094215 filed on Jun. 7, 2023, the entire content of which is incorporated herein by reference.

### BACKGROUND ART

PATENT LITERATURE 1 discloses a virtualization system virtualized by a hypervisor (hereinafter also referred to as “HV”) in which the operation of an application in a virtual machine (hereinafter also referred to as “VM”) is monitored, and a request from the VM to the HV in the virtualization system is monitored, thereby detecting an abnormality.

### CITATION LIST

### Patent Literature

PATENT LITERATURE 1: International Publication No. WO2022/185626
PATENT LITERATURE 2: Japanese Laid-Open Patent Publication No. 2012-168755
PATENT LITERATURE 3: International Publication No. WO2022/130743
PATENT LITERATURE 4: International Publication No. WO2022/254521
PATENT LITERATURE 5: US Patent Application Publication No. 2012/0324236
PATENT LITERATURE 6: International Publication No. WO2019/237072

### SUMMARY OF THE INVENTION

An abnormality detection device according to an aspect of the present disclosure is an abnormality detection device that detects an abnormality in one or more virtual systems included in a virtualization system configured on hardware, and the device includes: a measurement unit configured to measure at least one of a first period and a second period in a repetition of the first period and the second period, the first period being an execution period of the virtual system, the second period being an execution period of a virtual machine executed in the virtual system; and an abnormality detection unit configured to detect an abnormality in the virtual system, based on at least one of the first period and the second period measured by the measurement unit.

### BRIEF DESCRIPTION OF DRAWINGS

FIG. 1 is a block diagram showing an example of a configuration of an in-vehicle system according to a first embodiment.

FIG. 2 is a block diagram showing an example of a configuration of an in-vehicle device according to the first embodiment.

FIG. 3 is a schematic diagram illustrating a virtual environment in an in-vehicle device according to the first embodiment.

FIG. 4 illustrates an example of time management by a hypervisor.

FIG. 5 illustrates an example of measurement of an execution period of a virtual machine.

FIG. 6 is a flowchart showing an example of a measurement process by a measurement program in an in-vehicle device according to the first embodiment.

FIG. 7 is a flowchart showing an example of an abnormality detection process by an abnormality detection program in an in-vehicle device according to the first embodiment.

FIG. 8 shows a result of Simulation 1.

FIG. 9 shows a result of abnormality detection in Simulation 1.

FIG. 10 shows a result of Simulation 2.

FIG. 11 shows a result of abnormality detection in Simulation 2.

FIG. 12 is a schematic diagram illustrating a virtual environment in an in-vehicle device according to a second embodiment.

FIG. 13 is a schematic diagram illustrating a virtual environment in an in-vehicle device according to a third embodiment.

FIG. 14 is a schematic diagram illustrating a virtual environment in an in-vehicle device according to a fourth embodiment.

FIG. 15 is a schematic diagram illustrating a virtual environment in an in-vehicle device according to a fifth embodiment.

FIG. 16 is a schematic diagram illustrating a virtual environment in an in-vehicle device according to a sixth embodiment.

### DETAILED DESCRIPTION

However, the system disclosed in PATENT LITERATURE I can only detect predetermined types of abnormalities.

### Effects of the Present Disclosure

According to the present disclosure, it is possible to detect an abnormality that occurs in a hypervisor regardless of the type of abnormality.

### Description of Embodiment of the Present Disclosure

Hereinafter, outlines of an embodiment of the present disclosure will be listed and described.
(1) An abnormality detection device according to the present embodiment is an abnormality detection device that detects an abnormality in one or more virtual systems included in a virtualization system configured on hardware, and the device includes: a measurement unit configured to measure at least one of a first period and a second period in a repetition of the first period and the second period, the first period being an execution period of the virtual system, the second period being an execution period of a virtual machine executed in the virtual system; and an abnormality detection unit configured to detect an abnormality in the virtual system, based on at least one of the first period and the second period measured by the measurement unit. If the virtual system is subjected to an attack such as tampering, unauthorized processing occurs in the virtual system, and the first period or the second period becomes abnormally long. Therefore, abnormalities that occur in the virtual system, not limited to specific types of abnormalities, can be detected based on at least one of the first period and the second period.
(2) In the above (1), the measurement unit may measure the second period by recording a start time and an end time of processing performed by the virtual machine, and calculating a difference between the end time and the start time having been recorded. The second period can be measured by recording, using time stamps, the start time and the end time of the processing performed by the virtual machine.
(3) In the above (2), the measurement unit may measure the first period by calculating a difference between the start time and the end time having been recorded. The first period can be measured by recording, using time stamps, the start time and the end time of the processing performed by the virtual machine.
(4) In the above (2) or (3), the measurement unit may estimate a start timing of the second period by the virtual machine and record the start time by acquiring time information at the estimated start timing, and may estimate an end timing of the second period and record the end time by acquiring time information at the estimated end timing. The virtual machine cannot recognize the start and end of processing. Therefore, with the above configuration, for example, the virtual machine can record the start and end times of the processing of the virtual machine.
(5) In the above (4), the measurement unit may estimate, as the end timing, a timing after a certain period has elapsed since the start time was recorded. This allows the virtual machine itself to estimate the end timing of the processing of the virtual machine.
(6) In the above (5), the certain period may be a period shorter than a remaining time of the second period from the recording of the start time. It is conceivable that, if the end timing cannot be accurately estimated, for example, a timing after the execution period of the processing of the virtual machine has ended may be erroneously estimated as the end timing. With the above configuration, a timing before the execution period of the processing of the virtual machine ends can be estimated as the end timing.
(7) In any one of the above (4) to (6), the measurement unit may estimate a start timing of a second period in a next cycle, based on the remaining time of the second period from the recording of the start time, and a margin period. Thus, the start time and the end time of the second period can be recorded over a plurality of cycles.
(8) In any one of the above (1) to (7), the abnormality detection unit may detect the abnormality if the first period measured by the measurement unit deviates from a first normal range or if the second period deviates from a second normal range. Thus, abnormalities that occur in the virtual system, not limited to specific types of abnormalities, can be detected.
(9) In any one of the above (1) to (8), the abnormality detection unit may be included in the virtual machine. Thus, an abnormality in the virtual system can be detected while suppressing the influence of the abnormality that occurs in the virtual system.
(10) In any one of the above (1) to (8), the abnormality detection unit may be implemented by a processor different from a processor that executes the virtual system. Thus, an abnormality in the virtual system can be accurately detected while suppressing the influence of the abnormality that occurs in the virtual system.
(11) In any one of the above (1) to (8), the abnormality detection unit may be implemented by a hardware security module. Thus, an abnormality can be detected by a hardware security module (HSM) having security measures provided.
(12) In any one of the above (1) to (8), the abnormality detection unit may be included in a second virtual system that is different from a first virtual system that is the virtual system. This, an abnormality in the first virtual system can be detected while suppressing the influence of the abnormality that occurs in the first virtual system.
(13) In any one of the above (1) to (12), the measurement unit may be included in the virtual machine. Thus, the first period and the second period can be measured while suppressing the influence of an abnormality that occurs in the virtual system.
(14) In any one of the above (1) to (8), the measurement unit may be included in the first virtual machine that is the virtual machine, and the abnormality detection unit may be included in a second virtual machine that is executed in a second virtual system different from the first virtual system that is the virtual system. Thus, the first period and the second period can be measured while suppressing the influence of an abnormality that occurs in the virtual system.
(15) In the above (14), the measurement unit may provide information indicating the first period and the second period having been measured to the abnormality detection unit via a shared memory. Thus, information on the result of measurement by the measurement unit can be transferred from the first virtual machine to the second virtual machine.
(16) An abnormality detection method according to the present embodiment is a method for detecting an abnormality in one or more virtual systems included in a virtualization system configured on hardware, and the method includes: measuring at least one of a first period and a second period in a repetition of the first period and the second period, the first period being an execution period of the virtual system, the second period being an execution period of a virtual machine executed in the virtual system; and detecting an abnormality in the virtual system, based on at least one of the first period and the second period having been measured. Therefore, abnormalities that occur in the virtual system, not limited to specific types of abnormalities, can be detected based on at least one of the first period and the second period.
(17) An abnormality detection program according to the present embodiment is a program for detecting an abnormality in one or more virtual systems included in a virtualization system configured on hardware, and the program causes a computer to execute: measuring at least one of a first period and a second period in a repetition of the first period and the second period, the first period being an execution period of the virtual system, the second period being an execution period of a virtual machine executed in the virtual system; and detecting an abnormality in the virtual system, based on at least one of the first period and the second period having been measured. Therefore, abnormalities that occur in the virtual system, not limited to specific types of abnormalities, can be detected based on at least one of the first period and the second period.

The present disclosure can be realized not only as an abnormality detection device including such a characteristic configuration as above, an abnormality detection method having such characteristic process steps, and an abnormality detection program causing a computer to execute such characteristic processing, but also as an abnormality detection system including the abnormality detection device. In addition, a part or the entirety of the abnormality detection device can be realized as a semiconductor integrated circuit.

### Details of Embodiments of the Present Disclosure

Hereinafter, embodiments of the present disclosure will be described in detail with reference to the drawings. At least some parts of the embodiments described below may be combined together as desired.

### 1. First Embodiment

### 1-1. In-Vehicle System

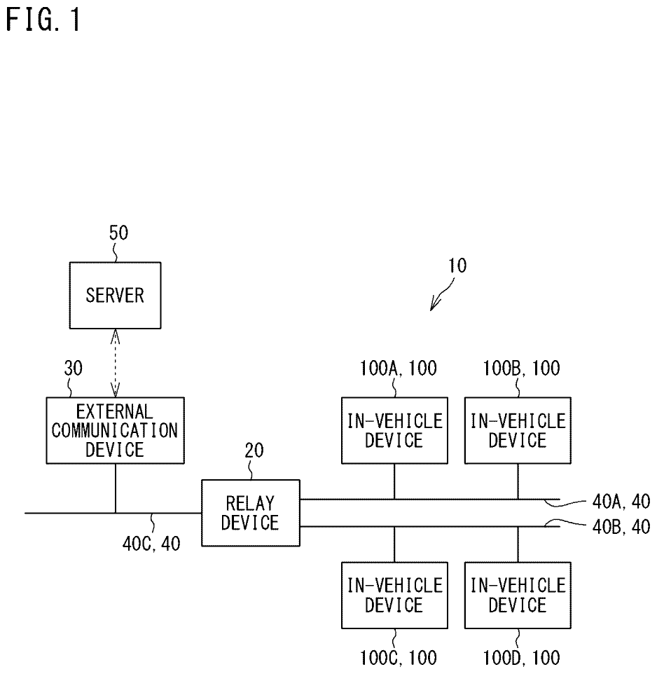

FIG. 1 is a block diagram showing an example of a configuration of an in-vehicle system according to the first embodiment. An in-vehicle system 10 is installed in a vehicle. The in-vehicle system 10 according to the first embodiment includes in-vehicle devices 100A, 100B, 100C, 100D, a relay device 20, and an external communication device 30. The in-vehicle devices included in the in-vehicle system 10 are not limited to the in-vehicle devices 100A, 100B, 100C, 100D, and in-vehicle devices not shown may be included in the in-vehicle system 10. The in-vehicle system 10 is an in-vehicle network configured by the in-vehicle devices 100A, 100B, 100C, 100D, the relay device 20, the external communication device 30, and communication cables (communication buses 40A, 40B, 40C) connecting them.

A plurality of in-vehicle devices 100A, 100B, 100C, 100D are disposed in various parts of the vehicle. The in-vehicle devices 100A, 100B, 100C, 100D individually control the hardware of each part of the vehicle and monitor the state of the hardware of each part of the vehicle. For example, the in-vehicle devices 100A, 100B, 100C, 100D are control-related, body-related, and information-related ECUs (Electronic Control Units). In the following description, the in-vehicle devices 100A, 100B, 100C, 100D are collectively referred to as “in-vehicle device 100”.

The relay device 20 is connected to the in-vehicle devices 100A, 100B, 100C, 100D via buses 40A, 40B, 40C, such as a CAN (Controller Area Network) bus. Specifically, the in-vehicle devices 100A, 100B are connected to the bus 40A. The in-vehicle devices 100C, 100D are connected to the bus 40B. The external communication device 30 is connected to the bus 40C. The relay device 20 relays communication between the buses 40A, 40B, 40C.

The relay device 20 and the in-vehicle device 100 use a specific communication protocol. The communication protocol is, for example, CAN, CAN FD (CAN with Flexible Data Rate), or Ethernet (registered trademark).

The relay device 20 functions as a gateway that relays communication between the plurality of in-vehicle devices 100. The in-vehicle devices 100 can transmit messages. The relay device 20 relays messages between the in-vehicle devices 100 connected to different buses. For example, the relay device 20 can relay messages between the in-vehicle device 100A connected to the bus 40A and the in-vehicle device 100C connected to the bus 40B.

The relay device 20 is connected to the external communication device 30 via the bus 40C. The external communication device 30 is, for example, a wireless communication terminal conforming to 5G or 4G, such as a TCU (Telematics Control Unit). The external communication device 30 can communicate with a server 50. The external communication device 30 and the relay device 20 relay communication between the server 50 and the in-vehicle device 100.

### 1-2. Configuration of In-Vehicle Device

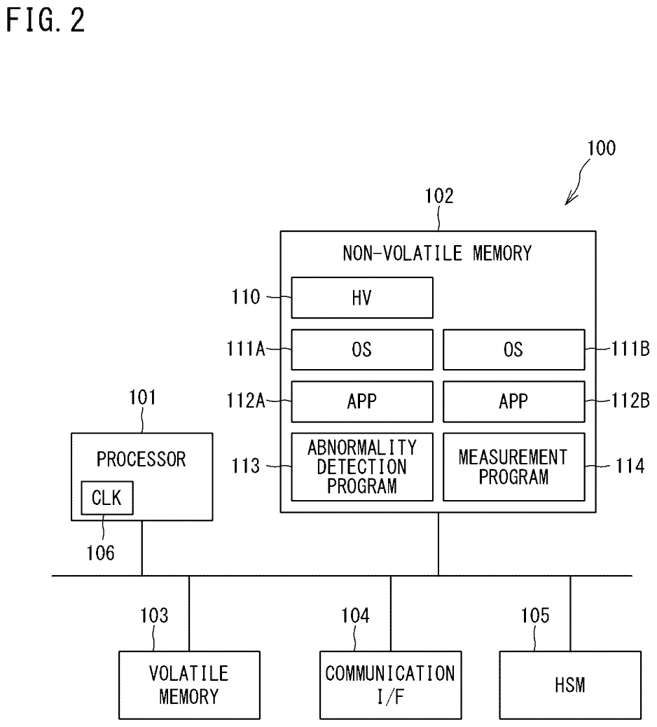

FIG. 2 is a block diagram showing an example of a configuration of an in-vehicle device according to the first embodiment. The in-vehicle device 100 includes a processor 101, a non-volatile memory 102, a volatile memory 103, a communication interface (I/F) 104, and a hardware security module (HSM) 105.

The volatile memory 103 is, for example, a semiconductor memory such as an SRAM (Static Random Access Memory) or a DRAM (Dynamic Random Access Memory), The non-volatile memory 102 is, for example, a flash memory, a hard disk, or the like. The non-volatile memory 102 is capable of reading and writing data.

The processor 101 is, for example, a CPU (Central Processing Unit). However, the processor 101 is not limited to a CPU. The processor 101 may be a GPU (Graphics Processing Unit). The processor 101 is configured to be able to execute a computer program. However, the processor 101 may include an ASIC (Application Specific Integrated Circuit) in a part thereof, or may include a programmable logic device such as an FPGA (Field Programmable Gate Array) in a part thereof.

The processor 101 includes a clock (CLK) 106. The clock 106 outputs a clock signal in a constant cycle. The processor 101 includes, for example, a time stamp counter (TSC) (not shown), and the TSC can stamp the time of the processor 101. The time stamped by the TSC is the internal time of the in-vehicle device 100. The internal time of the in-vehicle device 100 is, for example, an absolute time synchronized with an NTP (Network Time Protocol) server. The absolute time is, for example, Japan Standard Time (JST). In another example, it is Universal Time Coordinated (UTC). Hereinafter, the internal time of the in-vehicle device 100 is also referred to as “system time”.

The communication I/F 104 is a communication interface that complies with the communication protocol for the in-vehicle network described above. The communication I/F 104 includes one communication port, and is connected to one of the buses 40A, 40B, 40C. Hereinafter, the buses 40A, 40B, 40B are collectively referred to as “bus 40”. The communication I/F 104 is connected to each of the in-vehicle device 100 and the relay device 20 via the bus 40. The communication I/F 104 allows the in-vehicle device 100 to communicate with another in-vehicle device 100, the relay device 20, and the external communication device 30. Furthermore, the communication I/F 104 allows the in-vehicle device 100 to communicate with the server 50 via the external communication device 30.

The non-volatile memory 102 has, installed therein, a hypervisor (HV) 110, operating systems (OS) 111A, 111B, and applications (APP) 112A, 112B. The HV 110 is executed by the processor 101, and causes the in-vehicle device 100 to function as a virtual machine. Some or all of the HV 110, the OS 111A, 111B, and the APP 112A, 112B may be loaded into the volatile memory 103 and executed.

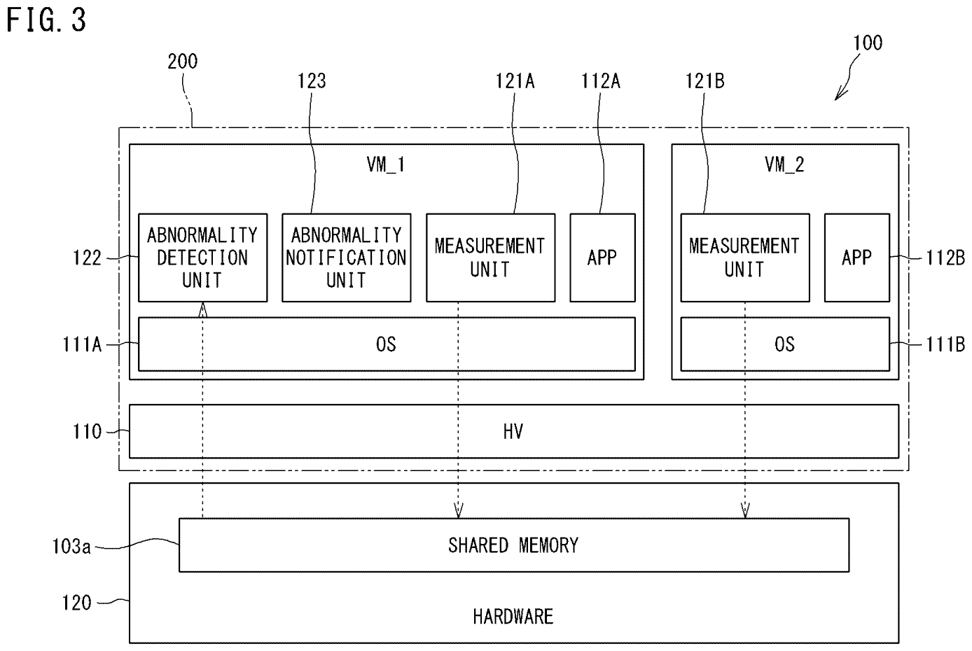

FIG. 3 is a schematic diagram illustrating a virtualization system in an in-vehicle device according to the first embodiment. The HV 110 operates on hardware 120 (processor 101, non-volatile memory 102, volatile memory 103, communication I/F 104, etc.). The HV 110 can emulate virtual hardware (HW). The HV 110 is a virtual system obtained by virtualizing hardware. A virtual machine VM_1 is realized by emulating a virtual HW, and a virtual machine VM_2 is realized by emulating another virtual HW. Here, the “virtualization system” refers to the entire computer system virtualized by the HV 110 in the in-vehicle device 100. The virtualization system 200 is configured on the hardware 120, and includes the HV 110, the VM_1, the OS 111A and APP 112A executed in the VM_1, the VM_2, and the OS 111B and APP 112B executed in the VM_2. In the first embodiment, the virtualization system 200 includes one HV 110. However, the virtualization system 200 may include a plurality of HVs. Although the number of virtual machines in one HV is two, the present disclosure is not limited thereto. For example, the number of virtual machines in one HV may be one, or three or more. It is sufficient if at least one in-vehicle device 100 has the HV virtualization system. That is, all the in-vehicle devices 100 may each have the HV virtualization system, or only some of the in-vehicle devices 100 may each have the HV virtualization system.

The OS 111A operates in the VM_1. In the VM_1, the APP 112A operates on the OS 111A. The OS 111B operates in the VM_2. In the VM_2, the APP 112B operates on the OS 111B. The APP 112A is, for example, engine control software. The processor 101, which executes the APP 112A, enables the in-vehicle device 100 to control the engine. The APP 112B is, for example, power window control software. The processor 101, which executes the APP 112B, enables the in-vehicle device 100 to control the power window.

The HV 110 manages the execution periods of the VM_1 and the VM_2. The execution period of the VM_1 and the execution period of the VM_2 are allocated in a time-division manner.

A partial area of the volatile memory 103 is used as a shared memory 103a. The shared memory 103a is a memory area that the VM_1 and the VM_2 can use.

Referring back to FIG. 2, the non-volatile memory 102 has, stored therein, an abnormality detection program 113 and a measurement program 114 which are computer programs. The non-volatile memory 102 has, stored therein, data used in the abnormality detection program 113 and the measurement program 114, for example. It is sufficient if at least one in-vehicle device 100 has the abnormality detection program 113 and the measurement program 114 installed therein. That is, all the in-vehicle devices 100 may each have the abnormality detection program 113 and the measurement program 114 installed therein, or only some of the in-vehicle devices 100 may each have the abnormality detection program 113 and the measurement program 114 installed therein. For example, the abnormality detection program 113 and the measurement program 114 may be installed in the in-vehicle device 100 having the HV 110 installed therein. Either one or both of the abnormality detection program 113 and the measurement program 114 may be loaded into the volatile memory 103 and executed.

The abnormality detection program 113 is a program for detecting abnormalities in the HV 110. For example, the HV 110 may be subjected to an attack such as hyperjacking, hypercall attack, hypervisor DOS (Denial of Services), VM escape attack, or cross-VM cache (side channel attack). The HV 110 subjected to such an attack may execute abnormal (illegal) processing or become unable to perform normal processing. The abnormality detection program 113 is a program for detecting such abnormalities.

The measurement program 114 is a program for acquiring data for detecting abnormalities in the HV 110. Specifically, the measurement program 114 is a program for measuring the execution periods of the VM_1, VM_2.

### 1-3. Function of In-Vehicle Device

The function of the in-vehicle device 100 will be described with reference to FIG. 3. The in-vehicle device 100 is an example of “abnormality detection device”.

The in-vehicle device 100 has the functions of measurement units 121A, 121B, an abnormality detection unit 122, and an abnormality notification unit 123. The processor 101, which executes the abnormality detection program 113, realizes the functions of the abnormality detection unit 122 and the abnormality notification unit 123. The processor 101, which executes the measurement program 114, realizes the functions of the measurement unit 121A and the measurement unit 121B.

The abnormality detection program 113 is a program executed in the VM_1. In the VM_1, the abnormality detection program 113 runs on the OS 111A. That is, the abnormality detection unit 122 and the abnormality notification unit 123 are the functions of the VM_1.

The measurement program 114 is a program executed in the VM_1 and the VM_2. In the VM_1, the measurement program 114 runs on the OS 111A. In the VM_2. the measurement program 114 runs on the OS 111B. That is, the measurement unit 121A is the function of the VM_1 and the measurement unit 121B is the function of the VM_2.

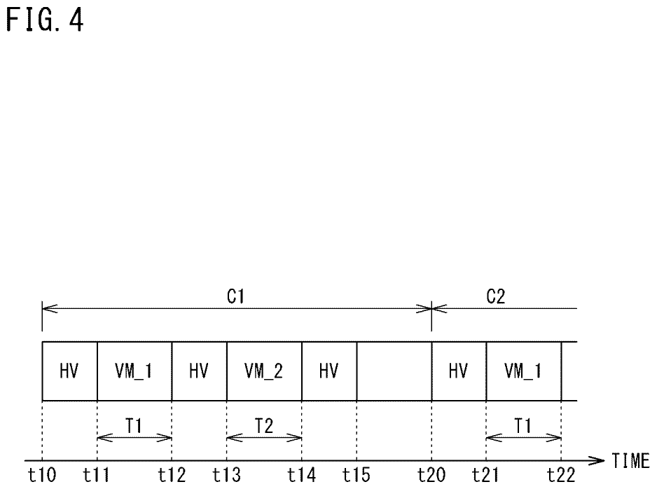

FIG. 4 illustrates an example of time management by a hypervisor. The HV 110 allocates the execution period of the HV 110, the execution period of the VM_1, and the execution period of the VM_2 in a time-division manner. Specifically, on the time schedule of the HV 110, a certain schedule cycle is repeated. Each schedule cycle includes the execution period of the HV 110, the execution period of the VM_1, and the execution period of the VM_2.

In FIG. 4, C1, C2 indicate schedule cycles. The schedule cycle C1 is started at time t10, and the execution period of the HV 110 is first allocated to a period from t10 to t11. A period from t11 to t12 is the execution period T1 of the VM_1, a period from t12 to t13 is the execution period of the HV 110, a period from t13 to t14 is the execution period T2 of the VM_2, and a period from t14 to t15 is the execution period of the HV 110. A period from t15 to t20 is an idle period. At time t20, the schedule cycle C1 ends and the next schedule cycle C2 starts.

Referring back to FIG. 3, the measurement units 121A, 121B measure the execution period of the HV 110, the execution period T1 of the VM_1, and the execution period T2 of the VM_2.

In a specific example, the measurement unit 121A measures the execution period T1 of the VM_1. The measurement unit 121B measures the execution period T2 of the VM_2.

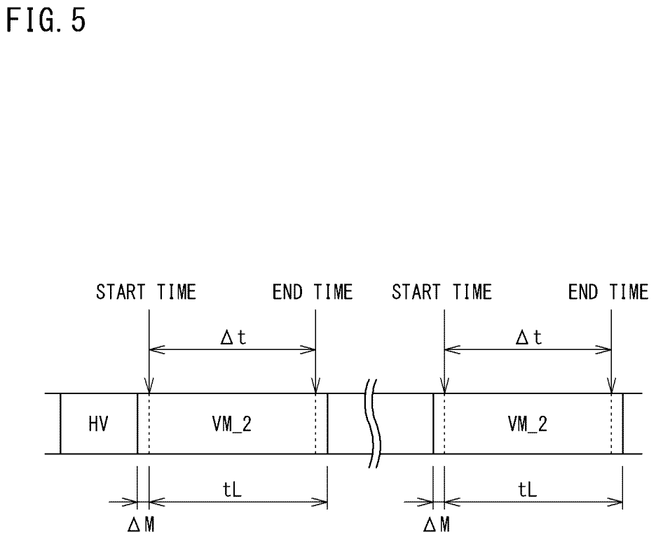

FIG. 5 illustrates an example of measurement of the execution period of the VM_2. Here, measurement of the execution period T2 of the VM_2 is described as a representative, and measurement of the execution period T1 of the VM_1 is similar.

The VM_2 can measure time using a timer based on the clock 106. This timer function of the VM_2 is a function that measures time (hereinafter also referred to as “local time”) only within the execution period of the VM_2, and cannot measure time in the execution period of the HV and the execution period of the VM_1. The VM_2 does not recognize the respective execution periods as separate periods, but recognizes them as a continuous period. That is, the VM_2 recognizes that the end of an execution period and the start of the next execution period are continuous. Therefore, the local time of the VM_2 is the time in which the end of an execution period and the start of the next execution period are continuous.

The VM_2 can recognize the start timing of the first execution period of the VM_2. However, as described above, the VM_2 cannot recognize the end timing of the first execution period thereof, and the start and end timings of the second and subsequent execution periods thereof.

After the VM_2 is activated, the VM_2 first activates the measurement unit 121B. That is, the measurement unit 121B is activated prior to the APP 112B. At the start timing of the first execution period of the VM_2 (i.e., the execution period immediately after the activation of the VM_2), more specifically, without a delay from the time when the VM_2 is activated, the measurement unit 121B records the start time in an internal memory of the in-vehicle device 100, e.g., the volatile memory 103. Hereinafter, recording of time information in an internal memory is also referred to as “time stamping”.

The measurement unit 121B estimates a timing when Δt has elapsed from the start time of the execution period, as the end timing of the execution period. At the start time of the execution period, the measurement unit 121B sets a first timer of the VM_2 to Δt. The Δt is a time corresponding to the length of one execution period, and specifically, is a period a predetermined time shorter than one execution period. The Δt is a period shorter than a remaining time tL described below.

The measurement unit 121B acquires the remaining time tL of the execution period. The measurement unit 121B estimates a timing after ΔM from the actual end time of the execution period (i.e., time after the remaining time tL has elapsed) as the start timing of the execution period of the VM_2 in the next schedule cycle. After the execution period of the VM_2, the next execution period of the VM_2 arrives after the execution period of the HV 110, the idle period, the execution period of the HV 110, the execution period of the VM_1, and the execution period of the HV 110 have elapsed. However, since the VM_2 can only recognize the above-described local time, the VM_2 recognizes that the next execution period is started at the time when tL has elapsed after the start time was stamped (it may be slightly earlier or later because there is a slight error in actuality). In other words, during the idle period, the execution period of the HV 110, and the execution period of the VM_1, the timers of the VM_2 (the above-described first timer and a second timer described below) stop. Therefore, for the VM_2, the timing when the remaining time tL and the ΔM have elapsed is the timing when ΔM has elapsed from the start of the next execution period.

The measurement unit 121B determines the timing when the remaining time tL has elapsed after the start time was stamped, as the actual end time of the execution period. The measurement unit 121B sets the second timer of the VM_2 to tL+ΔM that is estimated as the start timing of the execution period of the VM_2 in the next schedule cycle.

When the end timing has arrived, i.e., when the first timer has expired, the measurement unit 121B stamps the end time. In other words, the measurement unit 121B acquires the time information at the end timing, and records the acquired time information in the internal memory.

The measurement unit 121B stamps the start time at the timing when the remaining time tL and the ΔM have elapsed, i.e., the start timing of the execution period of the VM_2 in the next schedule cycle. That is, the measurement unit 121B records the start time by acquiring the time information at the start timing.

The ΔM is a margin time. Here, it is considered that the start time is stamped with the time point when the remaining time tL has elapsed being the start timing of the next execution period. In this case, if there is a fluctuation in time measurement due to the accuracy of the timer, it is conceivable that the start time of the next execution period is stamped before the previous execution period ends. The ΔM is a value that avoids such a stamping error and ensures that the start time is reliably stamped in the next execution period.

As with the first execution period described above, the measurement unit 121B estimates the timing when Δt has elapsed from the start time, as the end timing of the execution period, and stamps the end time when the end timing has arrived. Thereafter, the start time and the end time of each execution period are repeatedly stamped in the same manner as described above.

Referring back to FIG. 3, the measurement unit 121B measures the execution period (second period) T_VM2 of the VM_2, based on the time stamps of the start time and the end time acquired as described above. Specifically, the measurement unit 121B measures the execution period T_VM2 of the VM_2 by calculating a difference between the recorded end time and start time. Similarly, the measurement unit 121A measures the execution period T_VM1 of the VM_1 by calculating a difference between the recorded end time and start time. The measurement of T_VM2 is performed during the execution period of the VM_2. More specifically, the measurement of T_VM2 is performed repeatedly for each execution period of the VM_2. The measurement of T_VM1 is performed during the execution period of the VM_1. More specifically, the measurement of T_VM1 is performed repeatedly for each execution period of the VM_1.

Moreover, the measurement units 121A, 121B can measure an execution period T_HV1 of the HV 110. For example, the measurement unit 121B writes the recorded start time and end time together with the measured execution period of the VM_2 into the shared memory 103a. That is, the measurement unit 121B writes the execution period T_VM2 of the VM_2 and the start time and end time of the execution period of the VM_2 for each execution period of the VM_2 into the shared memory 103a. The measurement unit 121A reads out the start time and end time of the execution period of the VM_2 from the shared memory 103a. That is, the measurement unit 121A reads out the execution period T_VM2 of the VM_2 and the start time and end time of the execution period of the VM_2, for each execution period of the VM_1, from the shared memory 103a. Here, it is assumed that the schedule cycle next to the schedule cycle C1 is C2 and the schedule cycle C2 is currently being executed. The measurement unit 121A can measure the execution period T_HV1 of the HV 110 after the execution period of the VM_1 in the schedule cycle C2 and before the execution period of the VM_2 in the schedule cycle C2 by calculating a difference between the start time of the execution period of the VM_2 in the schedule cycle C2 and the end time of the execution period of the VM_1 in the schedule cycle C2. The measurement unit 121A can measure the execution period (and the idle period) T_HV2 of the HV 110 after the execution period of the VM_2 in the schedule cycle C1 and before the execution period of the VM_1 in the schedule cycle C2 by calculating a difference between the start time of the execution period of the VM_1 in the schedule cycle C2 and the end time of the execution period of the VM_2 in the schedule cycle C1.

The abnormality detection unit 122 detects an abnormality in the HV 110, based on the execution periods T_HV1, T_HV2 of the HV 110, the execution period T_VM1 of the VM_1, and the execution period T_VM2 of the VM_2 measured by the measurement units 121A, 121B. The abnormality detection in the HV 110 is repeatedly performed in synchronization with the schedule cycle.

Specifically, the abnormality detection unit 122 determines whether or not the execution period T_HVI of the HV 110 measured by the measurement units 121A, 121B deviates from a normal range R_HV1 (first normal range), and detects an abnormality in the HV 110 if the execution period T_HV1 deviates from the normal range R_HV1, The abnormality detection unit 122 determines whether or not the execution period T_HV2 of the HV 110 measured by the measurement units 121A, 121B deviates from a normal range R_HV2 (first normal range), and detects an abnormality in the HV 110 if the execution period T_HV2 deviates from the normal range R_HV2.

The abnormality detection unit 122 determines whether or not the execution period T_VM1 of the VM_1 measured by the measurement unit 121A deviates from a normal range R_VM1 (second normal range), and detects an abnormality in the HV 110 if the execution period T_VM1 deviates from the normal range R_VM1. The abnormality detection unit 122 determines whether or not the execution period T_VM2 of the VM_2 measured by the measurement unit 121B deviates from a normal range R_VM2 (second normal range), and detects an abnormality in the HV 110 if the execution period T_VM2 deviates from the normal range R_VM2.

In the above example, two virtual machines, VM_1 and VM_2, are realized on the HV 110. However, three or more virtual machines may be realized on the HV 110. An example in which three virtual machines, VM_1, VM_2, VM_3, are realized on the HV 110 is considered. In this case, for example, the measurement unit 121A operates on the VM_1, the measurement unit 121B operates on the VM_2, and the measurement unit 121C operates on the VM_3. The measurement unit 121B writes recognition information of the VM_2 together with the execution period of the VM_2 and the start time and end time of the execution period into the shared memory 103a. The measurement unit 121C writes recognition information of the VM_3 together with the execution period of the VM_3 and the start time and end time of the execution period into the shared memory 103a. The measurement unit 121A reads out the recognition information of the VM_2, the execution period of the VM_2 and its start time and end time, the recognition information of the VM_3, and the execution period of the VM_3 and its start time and end time, from the shared memory 103a. The measurement unit 121A specifies, from the recognition information, the execution period of the VM_2 and its start time and end time, and the execution period of the VM_3 and its start time and end time. For example, in the case where the VM_1, the VM_2, and the VM_3 are executed in this order in one schedule cycle, the measurement unit 121A measures the execution period T_HV1 of the HV 110 after the execution period of the VM_1 and before the execution period of the VM_2, by calculating a difference between the end time of the execution period of the VM_1 and the start time of the execution period of the VM_2 in one schedule cycle. The measurement unit 121A measures the execution period T_HV2 of the HV 110 after the execution period of the VM_2 and before the execution period of the VM_3, by calculating a difference between the end time of the execution period of the VM_2 and the start time of the execution period of the VM_3 in one schedule cycle. The measurement unit 121A measures the execution period (and the idle period) T_HV3 of the HV 110 after the execution period of the VM_3 in one schedule cycle and before the execution period of the VM_1 in the next schedule cycle, by calculating a difference between the end time of the execution period of the VM_3 in one schedule cycle and the start time of the execution period of the VM_1 in the next schedule cycle. Even if the number of virtual machines is four or more, the execution period of the HV 110 can be measured in a similar manner.

If the abnormality detection unit 122 detects an abnormality, the abnormality notification unit 123 notifies the detected abnormality.

For example, the abnormality notification unit 123 outputs notification data for notifying the detected abnormality. Specifically, the abnormality notification unit 123 generates a notification frame for notifying the detected abnormality, and transmits the generated notification frame to the in-vehicle network. For example, a user interface device (hereinafter referred to as “UI device”) is connected to the in-vehicle system 10 (not shown). The UI device is an in-vehicle device installed in a vehicle. The UI device is used by the driver of the vehicle. The UI device includes an input device and a display device, receives an input from the driver, and displays information to be provided to the driver. The UI device receives the notification frame transmitted from the in-vehicle device 100, and displays a screen for notifying the abnormality. Thus, the driver is notified of the abnormality.

In another example, a data storage device is connected to the in-vehicle system 10 (not shown). The data storage device is an in-vehicle device installed in the vehicle. The data storage device stores data regarding the abnormality detected by the abnormality detection unit 122 (hereinafter also referred to as “abnormality data”). The data storage device receives a notification frame transmitted from the in-vehicle device 100, and stores the abnormality data. Thus, the history of abnormality detection is stored, and for example, a maintenance technician responsible for vehicle servicing can refer to the history of abnormality detection.

In still another example, the external communication device 30 transmits a notification frame to a security department outside the vehicle. The security department is an organization that detects cyber-attacks, analyzes them, and advises on countermeasures. For example, the server 50 is used in the security department, and the notification frame is transmitted to the server 50. Based on the received notification frame, the server 50 notifies a terminal used by a security department staff member of the detected abnormality. Thus, an appropriate countermeasure is taken against the detected abnormality.

### 1-4. Operation of In-Vehicle Device

Hereinafter, the operation of the in-vehicle device according to the first embodiment will be described.

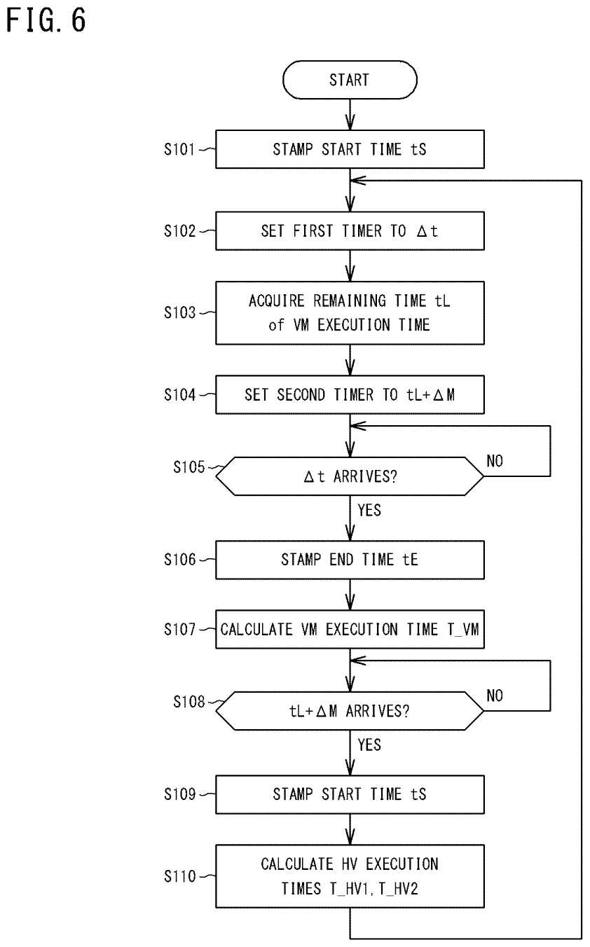

FIG. 6 is a flowchart showing an example of a measurement process by a measurement program in the in-vehicle device according to the first embodiment. In the following description, VM_1, VM_2 are collectively referred to as “VM”.

When the VM is activated, the first execution period is started. The processor 101 estimates that the time when ΔM has elapsed from the start of the first execution period of the VM is the start timing. When the start timing has arrived, the processor 101 stamps a start time TS (step S101). Thus, the start time TS is recorded.

The processor 101 sets the timer to Δt (step S102).

The processor 101 acquires the remaining time tL of the execution period of the VM (step S103). The processor 101 sets the timer to tL+ΔM (step S104).

The processor 101 determines whether or not Δt has arrived, i.e., whether or not the timer set to Δt has expired (step S105). If Δt has not arrived (NO in step S105), the processor 101 again executes step S105.

When Δt has arrived (YES in step S105), the processor 101 stamps an end time TE (step S106). Thus, the end time TE is recorded.

The processor 101 measures the execution period T_VM of the VM by calculating a difference TE-TS between the recorded start time TS and end time TE (step S107). The processor 101 writes the start time TS and the end time TE together with the execution period T_VM into the shared memory 103a.

The processor 101 determines whether or not tL+ΔM has arrived, i.e., whether or not the timer set to tL+ΔM has expired (step S108). If tL+ΔM has not arrived (NO in step S108), the processor 101 again executes step S108.

If tL+ΔM has arrived (YES in step S108), the processor 101 estimates that the start timing has arrived, and stamps a start time TS (step S109). The processor 101 writes the recorded start time TS in the shared memory 103a.

For example, in the VM_1, the processor 101 calculates the execution periods T_HV1, T_HV2 of the HV 110 (step S110). The T_HV1 is calculated as a difference between the end time of the execution period of the VM_1 in a target schedule cycle and the start time of the execution period of the VM_2 in the target schedule cycle. The T_HV2 is calculated as a difference between the end time of the execution period of the VM_2 in the schedule cycle immediately preceding the target schedule cycle and the start time of the execution period of the VM_1 in the target schedule cycle. For example, assuming that the target schedule cycle is C2 and the schedule cycle immediately preceding the schedule cycle C2 is C1, the execution period T_HV1 of the HV 110 is calculated as a difference between the end time of the execution period of the VM_1 in the schedule cycle C2 and the start time of the execution period of the VM_2 in the schedule cycle C2. The execution period T_HV2 of the HV 110 is calculated as a difference between the end time of the execution period of the VM_2 in the schedule cycle C1 and the start time of the execution period of the VM_1 in the schedule cycle C2. In step S110 for the first schedule cycle, since there is no previous schedule cycle, calculation for the execution period T_HV2 of the HV 110 is omitted. Step S110 is omitted in the measurement process of the VM_2.

The processor 101 returns to step S102. Thus, steps S102 to S110 are repeated.

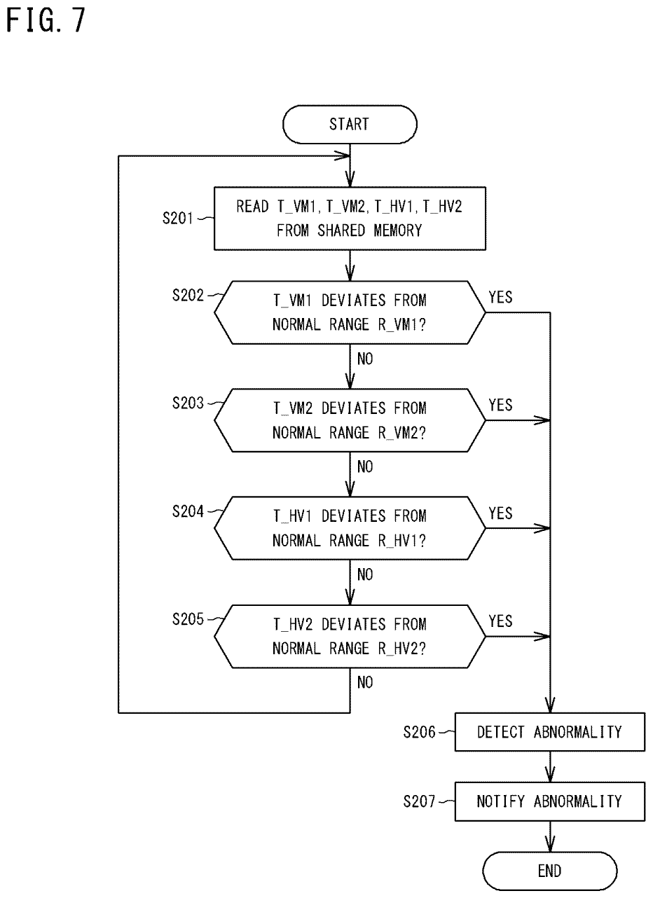

FIG. 7 is a flowchart showing an example of an abnormality detection process by an abnormality detection program in an in-vehicle device according to the first embodiment.

The processor 101 reads out T_VM1, T_VM2, T_HV1, and T_HV2 from the shared memory 103a (step S201).

The processor 101 determines whether or not T_VM1 deviates from the normal range R_VM1 (step S202).

When T_VM1 is within the normal range R_VM1 (NO in step S202), the processor 101 determines whether or not T_VM2 deviates from the normal range R_VM2 (step S203).

When T_VM2 is within the normal range R_VM2 (NO in step S203), the processor 101 determines whether or not T_HV1 deviates from the normal range R_HV1 (step S204).

When T_HV1 is within the normal range R_HV1 (NO in step S204), the processor 101 determines whether or not T_HV2 deviates from the normal range R_HV2 (step S205).

When T_HV2 is within the normal range R_HV2 (NO in step S205), the processor 101 returns to step S201. For example, the loop of the abnormality detection process is controlled in synchronization with the schedule cycle. Specifically, the processor 101 returns to step S201 when the timer in the same cycle as the schedule cycle has expired. In another example, the processor 101 may return to step S201 by being called from the measurement program 114.

If any one of T_VM1, T_VM2, T_HV1, T_HV2 deviates from the normal ranges R_VM1, R_VM2, R_HV1, R_HV2 (YES in steps S202, S203, S204, S205), the processor 101 detects an abnormality in the HV 110 (step S206).

The processor 101 notifies the detected abnormality (step S207). That is, for example, the processor 101 notifies the driver of the abnormality, stores abnormality data in the data storage device, or notifies the security department of the abnormality. This is the end of the abnormality detection process.

In the abnormality detection process shown in FIG. 7, two virtual machines, VM_1 and VM_2, are realized on the HV 110. However, the number of virtual machines is not limited to two, and may be one, or three or more. If the number of virtual machines is three or more, the execution period of the HV 110 between the execution periods of the respective virtual machines is measured as described above. In the abnormality detection process, the processor 101 compares the execution period of each virtual machine with the normal range, and compares each execution period of the HV 110 with the normal range. If at least one of the execution periods of all the virtual machines and all the execution periods of the HV 110 deviates from the normal range, an abnormality is detected.

In a modification, the VM1, VM2 may not necessarily include the OS 111A, 111B. If the VM1, VM2 include the OS 111A, 111B, as described above, the abnormality detection unit 122, the abnormality notification unit 123, the measurement unit 121A, and the APP 112A are executed as application programs on the OS 111A, and the measurement unit 121B and the APP 112B are executed as application programs on the OS 111B. On the other hand, if the VM1, VM2 do not include the OS 111A, 111B, each of the abnormality detection unit 122, the abnormality notification unit 123, and the measurement unit 121A is realized as a function (interruption processing routine) in the APP 112A, and the measurement unit 121B is realized as a function (interruption processing routine) in the APP 112B.

If the VM1, VM2 do not include the OS 111A, 111B, each of the abnormality detection unit 122, the abnormality notification unit 123, and the measurement unit 121A realizes the function by an interruption (signal) generated by the VM1, and the measurement unit 121B realizes the function by an interruption generated by the VM2. Therefore, in such a configuration, after activation of the VM_2, the VM_2 only needs to transmit a signal for activating the measurement unit 121B to the APP 112B first. Similarly, after activation of the VM_1, the VM_1 only needs to transmit a signal for activating the measurement unit 121A to the APP 112A first. More specifically, after activation of the VM_1, the VM_1 transmits a signal for activating the measurement unit 121A to the APP 112A. Next, the VM1 transmits a signal for activating the abnormality detection unit 122 to the APP 112A. Next, the VM1 transmits a signal for activating the abnormality notification unit 123 to the APP 112A.

### 1-5. Simulation of Abnormality Detection

The inventors performed a simulation of an abnormality detection method according to the first embodiment. MATLAB (registered trademark) was used for the simulation.

### 1-4-1. Simulation 1

In the simulation, in one schedule cycle, the first execution period HV1 of the HV 110, the execution period VM1 of the VM_1, the second execution period HV2 of the HV 110, the execution period VM2 of the VM_2, the third execution period HV3 of the HV 110, and an idle period IDL were set to proceed in this order. Each of the execution periods HV1, HV2, HV3 of the HV 110 was set to 100 μs, the execution period VM1 of the VM_1 was set to 1000 μs, the execution period VM2 of the VM_2 was set to 500 μs, the idle period IDL was set to 200 μs, and the schedule cycle was set to 2000 μs.

Furthermore, the start time of the execution period VM1 of the VM_1 was stamped 100 μs after the actual start of the VM1, and the end time of the VM1 was stamped 900 μs after the actual start of the VM1 (i.e., 100 μs before the actual end of the VM1). The start time of the execution period VM2 of the VM_2 was stamped 100 μs after the actual start of the VM2, and the end time of the VM2 was stamped 400 μs after the actual start of the VM2 (i.e., 100 μs before the actual end of the VM2).

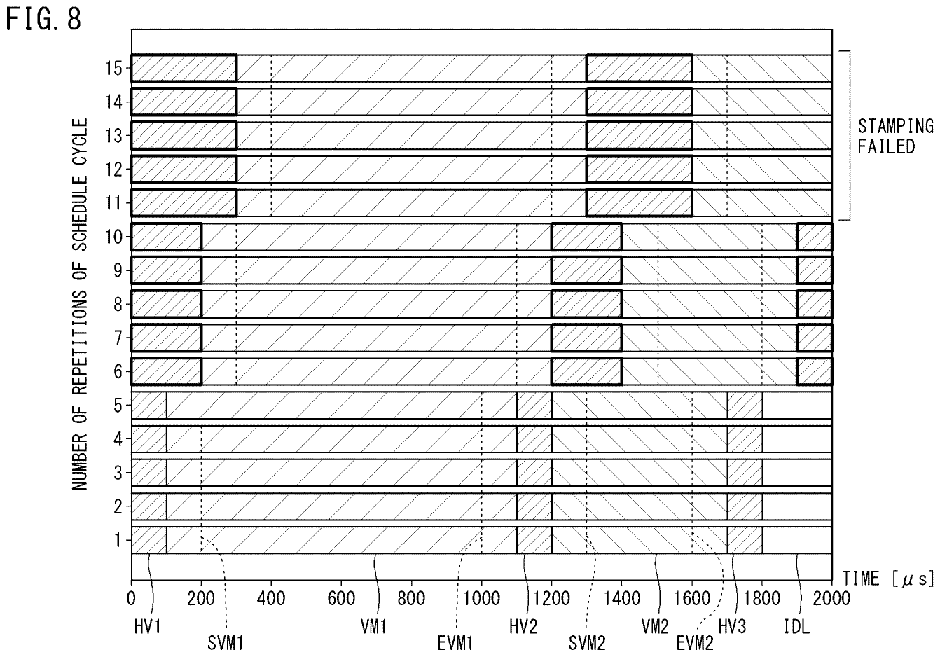

FIG. 8 shows a result of Simulation 1. In FIG. 8, the execution periods HV1, HV2, HV3 of the HV 110 extended due to an attack are shown in bold lines. A start time stamp timing SVM1 and an end time stamp timing EVM1 of the VM1, and a start time stamp timing SVM2 and an end time stamp timing EVM2 of the VM2 are shown in broken lines.

In Simulation 1, simulation was performed assuming that, in 15 schedule cycles, the HV1, HV2, HV3 from the 6th to 10th cycles were each changed from 100 μs to 200 μs (i.e., extended by 100 μs), and the HV1, HV2, HV3 from the 11th to 15th cycles were each changed from 100 μs to 300 μs (i.e., extended by 200 μs).

From the 6th to 10th cycles, since each of the HV1, HV2, HV3 is extended by 100 μs, the idle period IDL disappears and the schedule cycle ends midway through the HV3, Froth the 11th to 15th cycles, since each of the HV1, HV2, HV3 is extended by 200 μs, the idle period IDL and the HV3 disappear, and the schedule cycle ends midway through the VM2. As a result, the end time of the VM2 fails to be stamped.

In FIG. 8, a period from the start time stamp timing SVM1 to the end time stamp timing EVM1 of the VM1 is measured as the execution period T_VM1 of the VM_1. A period from the start time stamp timing SVM2 to the end time stamp timing EVM2 of the VM2 is measured as the execution period T_VM2 of the VM_2. A period from the end time stamp timing EVM1 of the VM1 to the start time stamp timing SVM2 of the VM2 is measured as the execution period T_HV1 of the HV 110. A period from the end time stamp timing EVM2 of the VM2 to the start time stamp timing SVM1 of the VM1 in the next schedule cycle is measured as the execution period T_HV2 of the HV 110.

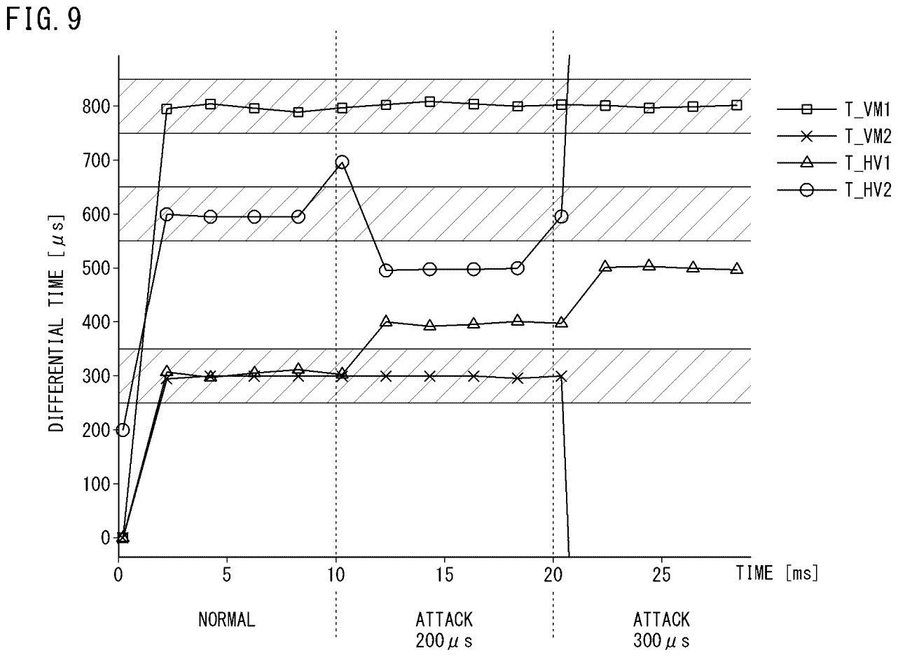

FIG. 9 shows a result of abnormality detection in Simulation 1. In this simulation, the normal range R_HV1 is set to 250 μs or more and 350 μs or less. The normal range R_HV2 is set to 550 μs or more and 650 μs or less. The normal range R_VM1 is set to 750 μs or more and 850 μs or less. The normal range R_VM2 is set to 250 μs or more and 350 μs or less. In FIG. 9, the normal ranges R_HV1, R_HV2, R_VM1, R VM2 are shown as hatched areas. The normal ranges R_HV1 and R_VM2 overlap each other and are shown as a single area.

In Simulation 1, from 2 ms to 8 ms after the start of the simulation, i.e., from the first cycle to the fourth cycle, each of the T_VM1, T_VM2, T_HV1, T_HV2 is within the normal range.

The T_VM1 is within the normal range R_VM1 throughout the simulation.

10 ms after the start of the simulation, i.e., in the 5th cycle, the T_HV2 is larger than the upper limit of the normal range R_HV2. Furthermore, from 12 ms to 18 ms (6th to 9th cycles), the T_HV2 is smaller than the lower limit of the normal range R_HV2. After 20 ms (from the 11th cycle onward), the T_HV2 significantly exceeds the upper limit of the normal range R_HV2. This is caused by a failure in stamping the end time of the VM2.

From 2 ms to 10 ms, i.e., from the 1st cycle to the 5th cycle, the T_HV1 is within the normal range R_HV1. From 12 ms onward, i.e., from the 6th cycle onward, the T_HV1 is larger than the upper limit of the normal range R_HV1.

From 2 ms to 20 ms, i.e., from the 1st cycle to the 10th cycle, the T_VM2 is within the normal range R_VM2. From 20 ms onward, i.e., from the 11th cycle onward, the T_VM2 is significantly lower than the lower limit of the normal range R_VM2. This is caused by a failure in stamping the end time of the VM2.

From the above, an abnormality is detected in the HV 110 after 10 ms, i.e., after the 5th cycle.

### 1-4-2. Simulation 2

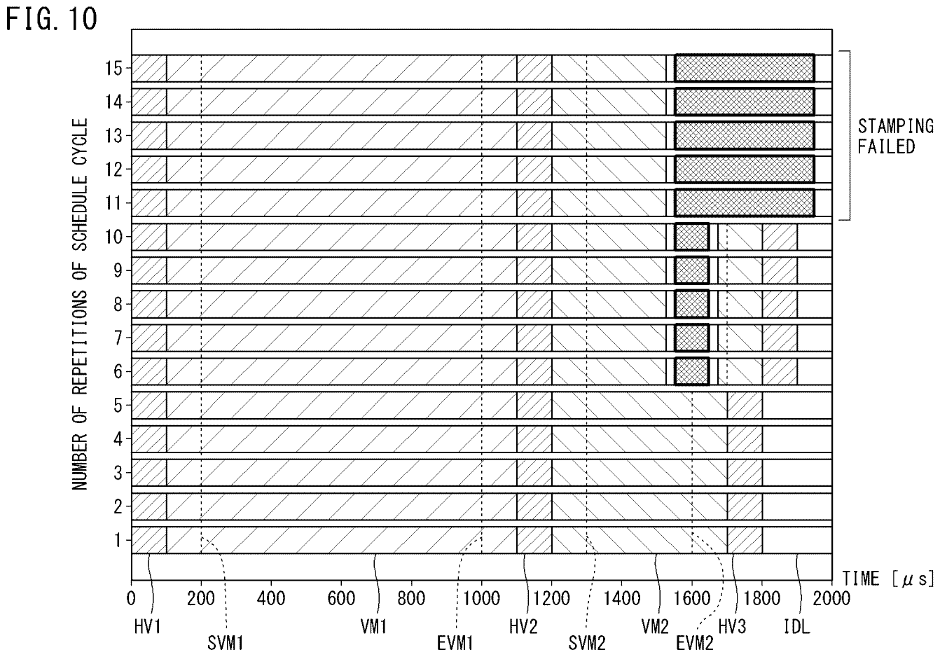

FIG. 10 shows a result of Simulation 2.

In Simulation 2, during 15 schedule cycles, interruption of an unauthorized execution period HVA of the HV 110 occurs in the middle of the VM2 from the 6th cycle to the 15th cycle. The length of an HVA from the 6th cycle to the 10th cycle is 100 μs, and the length of an HVA from the 11th cycle to the 15th cycle is 300 μs. The other conditions in Simulation 2 are the same as in Simulation 1.

From the 6th cycle to the 10th cycle, since an HVA interruption of 100 μs occurs, the end time of the HV3 is delayed by 100 μs and the idle period IDL is reduced by 100 μs.

From the 11th cycle to the 15th cycle, since an HVA interruption of 300 μs occurs, the idle period IDL and the HV3 disappear, and the schedule cycle ends in the middle of the VM2. As a result, the end time of the VM2 fails to be stamped.

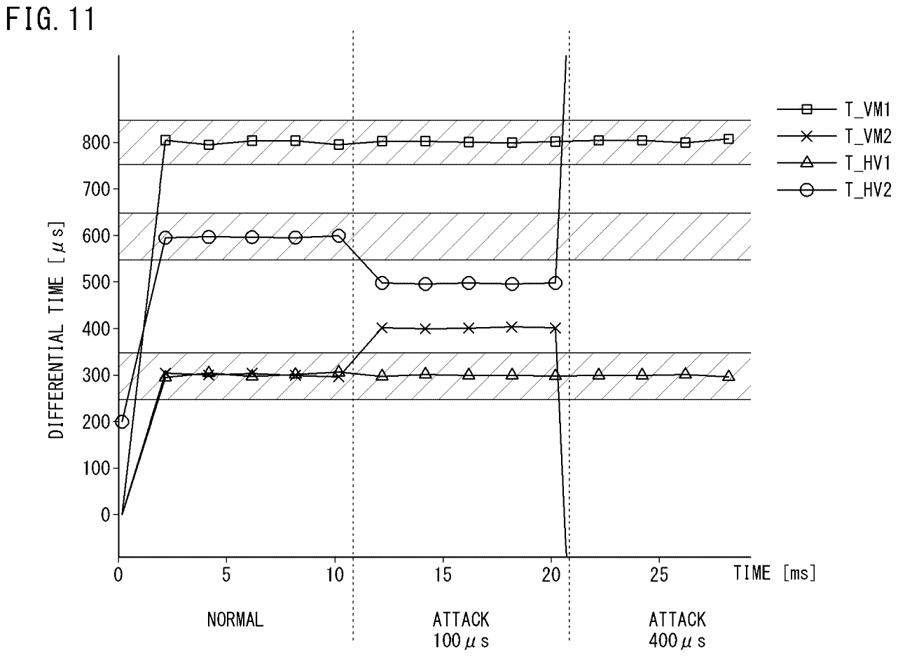

FIG. 11 shows a result of abnormality detection in Simulation 2. The normal ranges R_HV1, R_HV2, R_VM1, R_VM2 are the same as in Simulation 1.

In Simulation 2, from 2 ms to 10 ms after the start of the simulation, i.e., from the 1st cycle to the 5th cycle, each of the T_VM1, T_VM2, T_HV1, T_HV2 is within the normal range.

The T_VM1 is within the normal range R_VM1 throughout the simulation.

The T_HV1 is within the normal range R_HV1 throughout the simulation.

From 12 ms to 20 ms (from 6th cycle to 10th cycle), the T_HV2 is smaller than the lower limit of the normal range R_HV2. After 20 ms (from the 11th cycle onward), the T_HV2 significantly exceeds the upper limit of the normal range R_HV2. This is caused by a failure in stamping the end time of the VM2.

From 12 ms to 20 ms (6th cycle to 10th cycle), the T_VM2 is larger than the upper limit of the normal range R_VM2. After 20 ms (from the 11th cycle onward), the T_VM2 is significantly lower than the lower limit of the normal range R_VM2. This is caused by a failure in stamping the end time of the VM2.

From the above, an abnormality is detected in the HV 110 after 12 ms, i.e., after the 6th cycle.

### 2. Second Embodiment

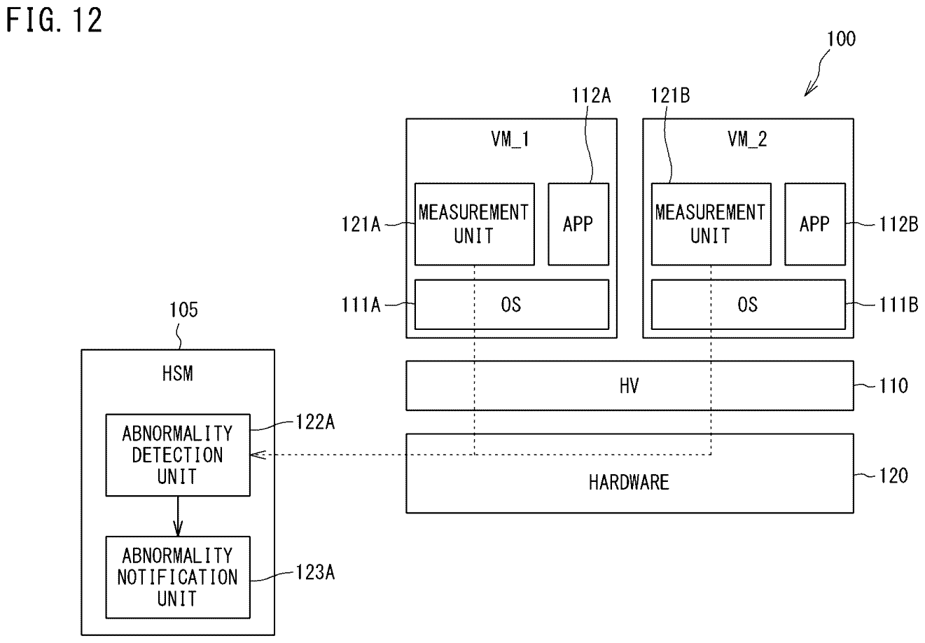

FIG. 12 is a schematic diagram illustrating a virtual environment in an in-vehicle device according to the second embodiment.

In the second embodiment, an HSM 105 has the functions of an abnormality detection unit 122A and an abnormality notification unit 123A. The VM_1 only has the function of the measurement unit 121A, and does not have the functions of the abnormality detection unit 122 and the abnormality notification unit 123.

In the second embodiment, the measurement unit 121B of the VM_2 outputs a measured T_VM2, and the outputted T_VM2 is inputted to the abnormality detection unit 122A of the HSM 105. The measurement unit 121A of the VM_1 outputs the measured T_VM1, T_HV1, T_HV2, and the outputted T_VM1, T_HV1, T_HV2 are inputted to the abnormality detection unit 122A of the HSM 105.

Based on the inputted T_VM1, T_VM2, T_HV1, T_HV2, the abnormality detection unit 122A detects an abnormality in the HV 110. Since the functions of the abnormality detection unit 122A and the abnormality notification unit 123A are the same as the functions of the abnormality detection unit 122 and the abnormality notification unit 123 of the first embodiment, repeated description is not necessary.

Since the abnormality detection unit 122A is provided in the HSM 105, the function of abnormality detection is not affected by an abnormality in the HV 110, and an abnormality can be accurately detected.

### 3. Third Embodiment

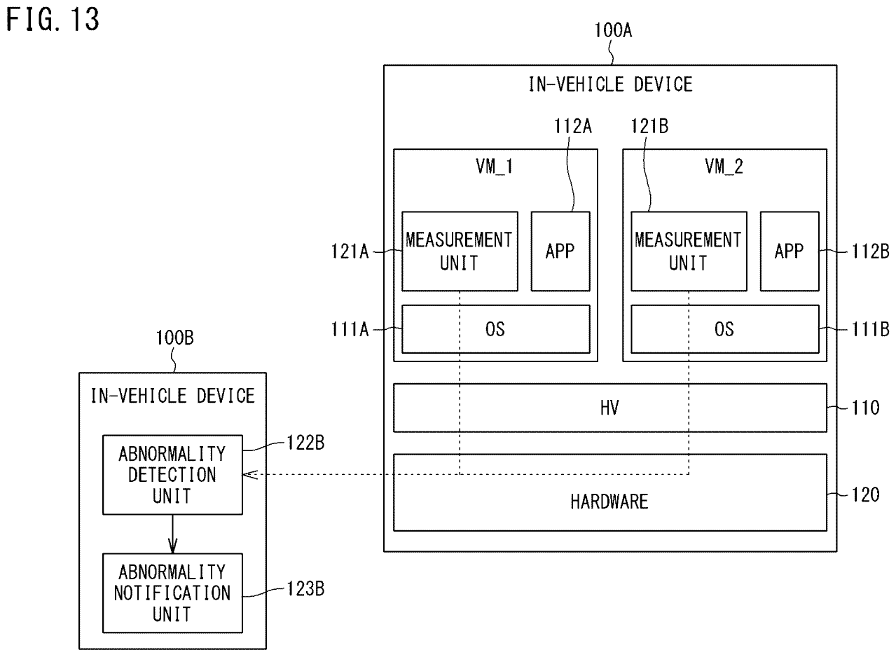

FIG. 13 is a schematic diagram illustrating a virtual environment in an in-vehicle device according to the third embodiment.

In the third embodiment, in the in-vehicle device 100A, the VM_1 only has the function of the measurement unit 121A, and does not have the functions of the abnormality detection unit 122 and the abnormality notification unit 123. An in-vehicle device 100B has the functions of the abnormality detection unit 122B and the abnormality notification unit 123B.

In the third embodiment, T_VM1, T_VM2, T_HV1, T_HV2 outputted from the measurement units 121A and 121B of the in-vehicle device 100A are transmitted to the in-vehicle device 100B through the in-vehicle network.

The in-vehicle device 100B receives the T_VM1, T_VM2, T_HV1, T_HV2, and the T_VM1, T_VM2, T_HV1, T_HV2 are inputted to the abnormality detection unit 122B. Based on the inputted T_VM1, T_VM2, T_HV1, T_HV2, the abnormality detection unit 122B detects an abnormality in the HV 110. Since the functions of the abnormality detection unit 122B and the abnormality notification unit 123B are the same as the functions of the abnormality detection unit 122 and the abnormality notification unit 123 of the first embodiment, repeated description is not necessary.

In the third embodiment, the abnormality detection unit 122B is realized by the processor (the processor 101 of the in-vehicle device 100B) different from the processor 101 of the in-vehicle device 100A that executes the HV 110. Thus, an abnormality in the HV 110 can be accurately detected while suppressing the influence of the abnormality that occurs in the HV 110 in the in-vehicle device 100A.

### 4. Fourth Embodiment

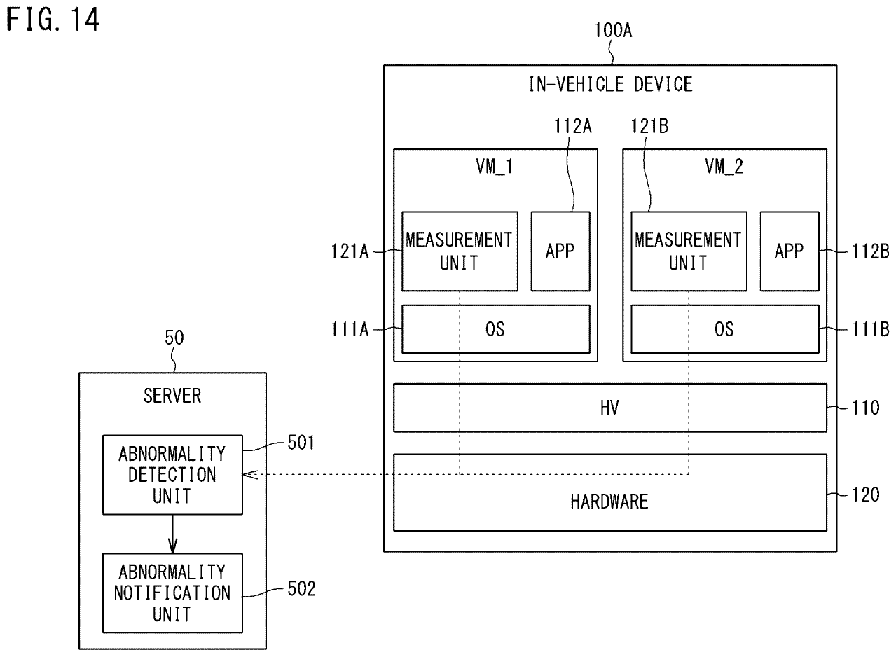

FIG. 14 is a schematic diagram illustrating a virtual environment in an in-vehicle device according to the fourth embodiment.

In the fourth embodiment, in the in-vehicle device 100, the VM_1 only has the function of the measurement unit 121A, and does not have the functions of the abnormality detection unit 122 and the abnormality notification unit 123. The server 50 has the functions of the abnormality detection unit 501 and the abnormality notification unit 502.

In the fourth embodiment, T_VM1, T_VM2, T_HV1, T_HV2 outputted from the measurement units 121A and 121B of the in-vehicle device 100 are transmitted to the server 50 through the external communication device 30.

The server 50 receives the T_VM1, T_VM2, T_HV1, T_HV2, and the T_VM1, T_VM2, T_HV1, T_HV2 are inputted to the abnormality detection unit 501. The abnormality detection unit 501 detects an abnormality in the HV 110, based on the inputted T_VM1, T_VM2, T_HV1, T_HV2. Since the functions of the abnormality detection unit 501 and the abnormality notification unit 502 are the same as the functions of the abnormality detection unit 122 and the abnormality notification unit 123 of the first embodiment, repeated description is not necessary.

In this fourth embodiment, the abnormality detection unit 501 is realized by a processor (processor of the server 50) different from the processor 101 of the in-vehicle device 100 that executes the HV 110. Thus, an abnormality in the HV 110 can be accurately detected while suppressing the influence of the abnormality that occurs in the HV 110 in the in-vehicle device 100.

### 5. Fifth Embodiment

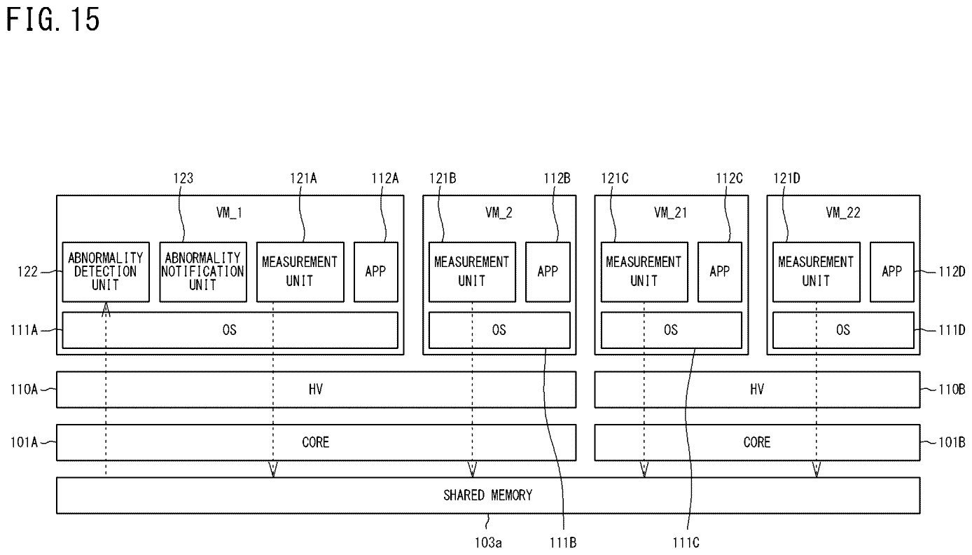

FIG. 15 is a schematic diagram illustrating a virtual environment in an in-vehicle device according to the fifth embodiment.

The processor 101 of the in-vehicle device 100 according to the fifth embodiment is a multicore processor including cores 101A and 101B. The processor 101 may have one clock, or each of the cores 101A, 101B may have a clock.

The core 101A executes an HV 110A, and the core 101B executes an HV 110B. The HV 110A configures VM_1, VM_2, and the HV 110B configures VM_21, VM_22.

An OS 111A operates in the VM_1. In the VM_1, an APP 112A operates on the OS 111A. An OS 111B operates in the VM_2. In the VM_2, an APP 112B operates on the OS 111B.

An OS 111C operates in the VM_21. In the VM_21, an APP 112C operates on the OS 111C. An OS 111D operates in the VM_22. In the VM_22, an APP 112D operates on the OS 111D,

The VM_1 has the functions of the measurement unit 121A, the abnormality detection unit 122, and the abnormality notification unit 123. The VM_2 has the function of the measurement unit 121B. The VM_21 has the function of the measurement unit 121C. The VM_22 has the function of the measurement unit 121D.

The functions of the measurement units 121A, 121B are the same as the functions of the measurement units 121A, 121B of the first embodiment. Even when each of the cores 101A, 101B has a clock, since the execution period of each virtual machine and the execution period of the HV do not depend on the time, the measurement units 121A, 121B can measure the execution period of each virtual machine and the execution period of the HV.

The measurement unit 121A measures the execution period T_VM1 of the VM_1 and the execution periods T_HV1, T_HV2 of the HV 110A. The measurement unit 121A writes the measured T_VM1, T_HV1, T_HV2 in the shared memory 103a.

The measurement unit 121B measures the execution period T_VM2 of the VM_2. The measurement unit 121B writes the measured T_VM2 in the shared memory 103a.

The measurement unit 121C measures the execution period of the VM_21 (hereinafter referred to as “T_VM21”). The measurement unit 121C measures the execution periods of the HV 110B (hereinafter referred to as “T_HV21” and “T_HV22”). The T_HV21 corresponds to the T_HV1 in the HV 110A, and the T_HV22 corresponds to the T_HV2 in the HV 110A.

The measurement unit 121C writes the measured T_VM21, T_HV21, T_HV22 in the shared memory 103a.

The measurement unit 121D measures the execution period of the VM_22 (hereinafter referred to as “T_VM22”). The measurement unit 121D writes the measured T_VM22 in the shared memory 103a.

The abnormality detection unit 122 reads out T_VM1, T_VM2, T_HV1, T_HV2, T_VM21, T_VM22, T_HV21, T_HV22 from the shared memory 103a.

The abnormality detection unit 122 determines whether or not the T_HV21 deviates from a normal range (hereinafter referred to as “R_HV21”). If the T_HV21 deviates from the normal range R_HV21, the abnormality detection unit 122 detects an abnormality in the HV 110B. The abnormality detection unit 122 determines whether or not the T_HV22 deviates from a normal range (hereinafter referred to as “R_HV22”). If the T_HV22 deviates from the normal range R_HV22, the abnormality detection unit 122 detects an abnormality in the HV 110B.

The abnormality detection unit 122 determines whether or not the VM_21 deviates from a normal range (hereinafter referred to as “R_VM21”). If the abnormality detection unit 122 deviates from the normal range R_VM21, the execution period T_VM21 detects an abnormality in the HV 110B. The abnormality detection unit 122 determines whether or not the VM_22 deviates from a normal range (hereinafter referred to as “R_VM22”). If the execution period T_VM22 deviates from the normal range R_VM22, the abnormality detection unit 122 detects an abnormality in the HV 110B.

If an abnormality is detected in the HV 110A, the abnormality notification unit 123 notifies the abnormality. If an abnormality is detected in the HV 110B, the abnormality notification unit 123 notifies the abnormality.

In the fifth embodiment, the abnormality detection unit is included in the HV 110A that is a virtual system different from the HV 110B that is a virtual system targeted for abnormality detection. Thus, an abnormality in the HV 110B can be accurately detected while suppressing the influence of the abnormality that occurs in the HV 110B.

### 6. Sixth Embodiment

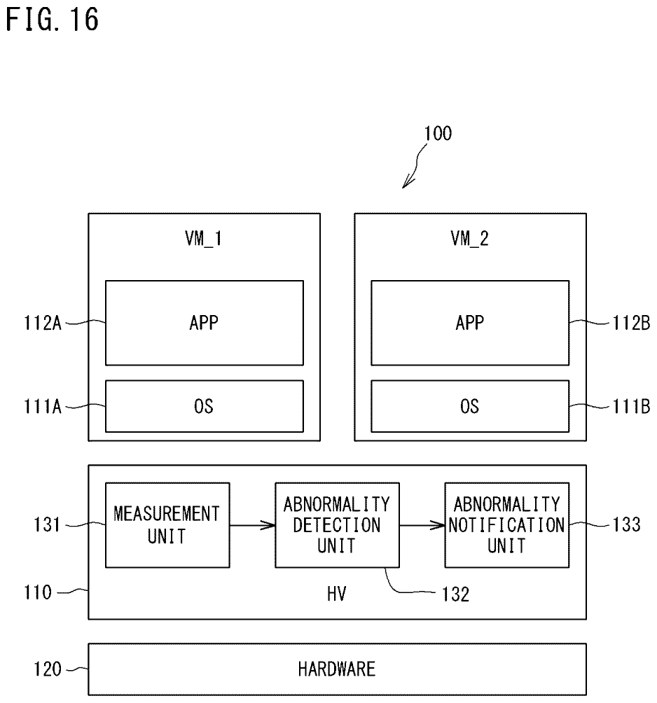

FIG. 16 is a schematic diagram illustrating a virtual environment in an in-vehicle device according to the sixth embodiment.

In the sixth embodiment, in the in-vehicle device 100, the HV 110 has the functions of the measurement unit 131, the abnormality detection unit 132, and the abnormality notification unit 133. The VM_1 does not have the functions of the measurement unit 121A, the abnormality detection unit 122, and the abnormality notification unit 123. The VM_2 does not have the function of the measurement unit 121B.

The measurement unit 131 measures the execution period T_VM1 of the VM_1, the execution period T_VM2 of the VM_2, and the execution periods T_HV1, T_HV2 of the HV 110.

The HV 110 manages the execution periods of the VM_1, VM_2 and the execution period of the HV 110. That is, the HV 110 measures the execution periods of the VM_1, VM_2 and the HV 110 using a timer. The HV 110 calls the VM_1 when the start time of the VM_1 has arrived, and switches to the execution period of the HV 110 when the end time of the execution period of the VM_1 has arrived. The HV 110 calls the VM_2 when the start time of the VM_2 has arrived, and switches to the execution period of the HV 110 when the end time of the execution period of the VM_2 has arrived.

In a specific example, the measurement unit 131 measures the T_VM1, T_VM2, T_HV1, T_HV2 using an execution period management function of the HV 110. That is, the measurement unit 131 measures the T_VM1, T_VM2, T_HV1, T_HV2 without stamping the start time and end time of the VM_1, VM_2.

Since the functions of the abnormality detection unit 132 and the abnormality notification unit 133 are the same as the functions of the abnormality detection unit 122 and the abnormality notification unit 123 of the first embodiment, repeated description is not necessary.

As described above, in the sixth embodiment, since the measurement unit 131 has the function of the HV 110, the start times of the VM_1, VM_2 need not be stamped, thereby simplifying the processing in the measurement unit 131.

### 7. Additional Note

The embodiments disclosed herein are merely illustrative in all aspects and should not be recognized as being restrictive. The scope of the present disclosure is defined by the scope of the claims rather than by the above embodiments, and is intended to include meaning equivalent to the scope of the claims and all modifications within the scope.

### REFERENCE SIGNS LIST

10 in-vehicle system
20 relay device
30 external communication device
40A, 40B, 40C communication bus
50 server
100, 100A, 100B, 100C, 100D in-vehicle device
101 processor
101A, 101B core
102 non-volatile memory
103 volatile memory
103a shared memory
104 communication interface (communication I/F)
105 hardware security module (HSM)
106 clock (CLK)
110, 110A, 110B hypervisor (HV, virtual system)
111A, 111B, 111C, 111D operating system (OS)
112A, 112B, 112C, 112D application (APP)
113 abnormality detection program
114 measurement program
120 hardware
121A, 121B, 121C, 121D, 131 measurement unit
122, 122A, 122B, 501, 132 abnormality detection unit
123, 123A, 123B, 502, 133 abnormality notification unit
200 virtualization system
VM_1, VM_2, VM_21, VM_22 virtual machine
C1, C2 schedule cycle
t10 to t15, t20 to t22 time
T1, T2, T_VM1, T_VM2, T_HV1, T_HV2, HV1, HV2, HV3, VM1, VM2,
T_VM21, T_VM22, T_HV21, T_HV22 execution period
R_HV1, R_HV2, R_VM1, R_VM2, R_HV21, R_HV22, R_VM21, R_VM22 normal range
SVM1, EVM1, SVM2, EVM2 stamp timing

1. An abnormality detection device that detects an abnormality in one or more virtual systems included in a virtualization system configured on hardware, the abnormality detection device comprising:
a measurement unit configured to measure at least one of a first period and a second period in a repetition of the first period and the second period, the first period being an execution period of the virtual system, the second period being an execution period of a virtual machine executed in the virtual system; and
an abnormality detection unit configured to detect an abnormality in the virtual system, based on at least one of the first period and the second period measured by the measurement unit.

2. The abnormality detection device according to claim 1, wherein
the measurement unit measures the second period by recording a start time and an end time of processing performed by the virtual machine, and calculating a difference between the end time and the start time having been recorded.

3. The abnormality detection device according to claim 2, wherein
the measurement unit measures the first period by calculating a difference between the recorded start time and end time.

4. The abnormality detection device according to claim 2, wherein
the measurement unit estimates a start timing of the second period by the virtual machine and records the start time by acquiring time information at the estimated start timing, and estimates an end timing of the second period and records the end time by acquiring time information at the estimated end timing.

5. The abnormality detection device according to claim 4, wherein
the measurement unit estimates, as the end timing, a timing after a certain period has elapsed since the start time was recorded.

6. The abnormality detection device according to claim 5, wherein
the certain period is a period shorter than an estimated remaining time of the second period from the recording of the start time.

7. The abnormality detection device according to claim 4, wherein
the measurement unit estimates a start timing of a second period in a next cycle, based on the estimated remaining time of the second period from the recording of the start time, and a margin period.

8. The abnormality detection device according to claim 1, wherein
the abnormality detection unit detects the abnormality if the first period measured by the measurement unit deviates from a first normal range or if the second period deviates from a second normal range.

9. The abnormality detection device according to claim 1, wherein
the abnormality detection unit is included in the virtual machine.

10. The abnormality detection device according to claim 1, wherein
the abnormality detection unit is implemented by a processor different from a processor that executes the virtual system.

11. The abnormality detection device according to claim 1, wherein
the abnormality detection unit is implemented by a hardware security module.

12. The abnormality detection device according to claim 1, wherein
the abnormality detection unit is included in a second virtual system that is different from a first virtual system that is the virtual system.

13. The abnormality detection device according to claim 1, wherein
the measurement unit is included in the virtual machine.

14. The abnormality detection device according to claim 1, wherein
the measurement unit is included in the first virtual machine that is the virtual machine, and
the abnormality detection unit is included in a second virtual machine that is executed in a second virtual system different from the first virtual system that is the virtual system.

15. The abnormality detection device according to claim 14, wherein
the measurement unit provides information indicating the first period and the second period having been measured to the abnormality detection unit via a shared memory.

16. An abnormality detection method for detecting an abnormality in one or more virtual systems included in a virtualization system configured on hardware, the method comprising:
measuring at least one of a first period and a second period in a repetition of the first period and the second period, the first period being an execution period of the virtual system, the second period being an execution period of a virtual machine executed in the virtual system; and
detecting an abnormality in the virtual system, based on at least one of the first period and the second period having been measured.

17. A non-transitory computer-readable storage medium having, stored therein, a abnormality detection program for detecting an abnormality in one or more virtual systems included in a virtualization system configured on hardware,
the abnormality detection program causing a computer to execute:
measuring at least one of a first period and a second period in a repetition of the first period and the second period, the first period being an execution period of the virtual system, the second period being an execution period of a virtual machine executed in the virtual system; and
detecting an abnormality in the virtual system, based on at least one of the first period and the second period having been measured.
